(19) United States
(12) Patent Application Publication
(10) Pub. No.: US 2024/0059079 A1
(43) Pub. Date: Feb. 22, 2024

(54) Printer with Paper Recycling Capability

(71) Applicant: Calvin T. Liu, Dunwoody, GA (US)

(72) Inventor: Calvin T. Liu, Dunwoody, GA (US)

(21) Appl. No.: 18/233,271

(22) Filed: Aug. 11, 2023

Related U.S. Application Data
(60) Provisional application No. 63/398,519, filed on Aug. 16, 2022.

(51) Int. Cl. B41J 3/407; B41J 11/00; B41J 2/44; B41J 2/06; B41J 11/58; B41J 29/16; B41J 2/21

(52) U.S. Cl. CPC B41J 3/407; B41J 11/009; B41J 2/442; B41J 2/06; B41J 11/58; B41J 29/16; B41J 2/2117; B41J 2002/061

(57) ABSTRACT

A printer can operate as a recycling device by drawing used paper, and printing over the printed portions of the used paper with coloring (e.g., toner or ink) that matches the color of the used paper.

### CROSS-REFERENCE TO RELATED APPLICATION

This application claims the benefit of U.S. Provisional Application No. 63/398,519, filed Aug. 16, 2022.

### TECHNICAL FIELD

The present application relates generally to the field of printers, and more specifically, to printing devices that have the capability of recycling paper.

### BACKGROUND

According to one source, the University of Southern Indiana (https://www.usi.edu/recycle/paper-recycling-facts), Americans use 85,000,000 tons of paper a year, which is about 680 pounds per person. The average household throws away 13,000 separate pieces of paper each year, with most of it being junk mail and packaging. Moreover, according to another source (https://www.recordnations.com/2020/01/schools-spend-paper-per-year/) schools use a significant amount of paper in just one day. A single teacher typically uses between 25-75 pages every day for handing out tests, homework, and resources to students.

However, each ton (2000 pounds) of recycled paper can save 17 trees, 380 gallons of oil, three cubic yards of landfill space, 4000 kilowatts of energy, and 7000 gallons of water.

The typical paper recycling process has many steps, and energy is actually being used to recycle that paper. According to one source (https://earth911.com/business-policy/paper-recycling-details-basics/), after paper is put into a recycling bin, it is transported to a recycling center where contaminants such as plastic, glass or trash are removed. Then the paper is sorted into different grades. After the paper is sorted, it is transferred to a mill for processing. Large machines (pulpers) at the mill shred the paper into small pieces. A combined mixture of paper, water, and chemicals is heated and the pieces of paper break down into fibers. The mixture is pressed through a screen to remove adhesives and other remaining contaminants Next, the paper is cleaned in by being spun in a cone-shaped cylinder. Sometimes ink will also be removed. This pulp mixture is then sent through a machine that sprays the pulp mixture onto a conveyor belt. Water drips through the conveyor belt's screen, and the paper fibers in the mixture start bonding together. Heated metal rollers then dry the paper, which afterwards is put onto large rolls. The rolls of paper can then be used to make into new paper products. Not only is this process lengthy and energy intensive (e.g., transporting the recycled paper takes fuel, energy is used to heat the recycled mixture, machinery that is used will use energy), but paper can only be recycled so many times before it starts to break down. Specifically, after being recycled five to seven times, the fibers become too short to make new paper, according to the EPA. Paper is said to have “seven generations,” and this refers to how many times paper can be recycled before its fibers become too short, and will need to be mixed with “virgin fibers” from paper fibers that have not been recycled yet.

The above-described background relating to paper and paper recycling is merely intended to provide a contextual overview and is not intended to be exhaustive. Other contextual information may become apparent in view of the following description.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example of a printer, in accordance with in accordance with various aspects and example embodiments of the subject application.

FIG. 2 illustrates an example of typical electronics-related components of a printer in accordance with various aspects and example embodiments of the subject application.

FIG. 3 illustrates an example of a printer coupled to a shredder, which can be attached to a shred bin, in accordance with various aspects and example embodiments of the subject application.

FIG. 4 illustrates a side view of an example of a printer coupled to a shredder, and an example of a printer having incorporated within its housing a shredder, in accordance with various aspects and example embodiments of the subject application.

FIG. 5 illustrates an example of a printing parameter associated with the recycling function of the printer operates, in accordance with various aspects and example embodiments of the subject application.

FIG. 6 illustrates an example of a printing parameter associated with the recycling function of the printer operates, in accordance with various aspects and example embodiments of the subject application.

FIG. 7 is an illustration of example operations that can be performed by the example printer, in accordance with various aspects and example embodiments of the subject application.

FIG. 8 is an illustration of another example operations that can be performed by the printer, in accordance with various aspects and example embodiments of the subject application.

FIG. 9 is an illustration of yet another example operations that can be performed by the printer, in accordance with various aspects and example embodiments of the subject application.

### DETAILED DESCRIPTION

The subject disclosure is now described with reference to the drawings, wherein like reference numerals are used to refer to like elements throughout. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings. In the following description, for purposes of explanation, numerous specific details are set forth in order to provide a more thorough understanding of the subject disclosure. It may be evident, however, that the subject disclosure can be practiced without these specific details. In other instances, structures and devices are shown in block diagram form to facilitate describing the subject disclosure.

In accordance with various aspects and example embodiments of the subject application, a printer is provided that can perform recycling functions. In the context of this application, the term printer as used herein can include a printer that copies, scans, faxes, and emails documents. Example embodiments of this printer will be referred to herein from time to time, for brevity, as the “recycling printer.”

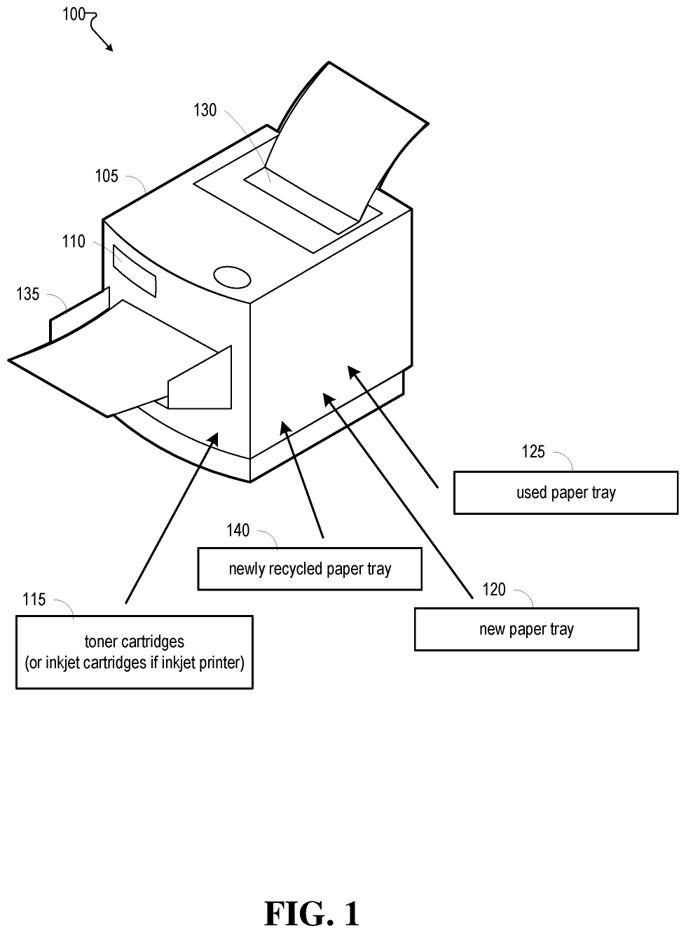

FIG. 1 depicts an illustration of the recycling printer 100 in accordance with various aspects and example embodiments of the subject application. The recycling printer 100 can comprise a housing 105, which can be made of some kind of plastic. The recycling printer 100 can have a user input interface 110 for receiving inputs from a user. It should be appreciated that the term “user” can refer to human entities, associated devices, or automated components supported through artificial intelligence (e.g., a capacity to make inference based on complex mathematical formalisms) which can provide simulated vision, sound recognition and so forth. The user input interface 110 can be a touchscreen, or a keypad, for adjusting print settings, entering email and fax destinations, or accessing documents (e.g., template documents, documents stored on a network drive such as those provided by OneDrive, Box, Dropbox, Google Drive, etc.). The recycling printer 100 can also be a laser printer and can comprise toner cartridges 115 (and in the case that the recycling printer is an inkjet printer, inkjet cartridges). Toners are powders that are used in printing images and text on papers. The heat from a laser printer's fuser melts the toner powder during the printing process and bonds it to the paper. The toner cartridges 115 can comprise toner that is black, cyan, magenta, and yellow in color (typically, some combination of these colors can be mixed to derive other colors). The toner cartridges 115 of the recycling printer can also comprise a white toner cartridge. For purposes of this application, a “coloring” can be used to refer to ink or toner, depending on whether the recycling printer is an inkjet or laser printer.

Still referring to FIG. 1, the recycling printer 100 can have various trays to hold paper to be processed and printed. It can have a new paper tray 120 for holding new paper (which can be paper bought from a store such as Office Depot, Office Max, Staples, Target, Walmart, or any other store). The recycling printer 100 can have a tray to hold paper that has been previously printed on (for brevity, also sometimes referred to herein as “used paper”), labeled in FIG. 1 as used paper tray 125. Paper can be fed into a paper feed tray 130, which can be located at any position desirable (e.g., for top loading, front loading, etc.). Paper that is output from the recycling printer 100 can rest on a paper output retainer 135.

The recycling printer 100 is operable to accept a piece of used paper, determine the areas of the paper that have been printed upon (e.g., using pattern recognition software), and print over the previously printed areas of the paper so as to substantially cover up the ink or toner that was applied onto the used paper.

As an example, if a used, white sheet of paper had text or an image printed on it. The test or image can be of any color—black, blue, red, yellow, etc. The recycling printer 100 can accept this used sheet of paper via, for example, paper feed tray 130, or drawing from the used paper tray 125. The recycling printer 100 can determine the areas that have been used (i.e., already printed upon), and then print over the text and image with white ink (e.g., lasered on using the white toner cartridge, if it is a laser printer). The white, which covers up the previously printed ink on the white paper, can render the sheet of paper usable again, at the minimum for some purposes. A person might be able to tell that this is a recycled piece of paper that has been printed over, and as such it may not be suitable for very formal documents that may need to be submitted, for example, as a resume for a job or a court filing document, but it can at least serve some purposes. For example, newly recycled paper processed by the recycling printer 100 can be used as scratch paper or for printing drafts of documents. If a teacher would be willing to accept it, it can also be used for any written homework or essays that would need to be turned in.

In example embodiments, in response to a user command to print a document (for example, when a user is using an application on his or her computer such as Microsoft Word, or Adobe PDF, and selects the print option from the menu and then initiates a print command to print the document upon which they are viewing), the recycling printer of the present application can send a command resulting in the display of an on-screen prompt to the user (on the user's computer or laptop display). The prompt can ask the user whether he or she desires to print on clean, new paper (e.g., store bought and unused, even if it was previously from recycled paper from a recycling plant or mill), or to print on recycled paper from the used paper tray 125 (paper that has already been printed upon). In response to the user indicating that he or she desired to print on recycled paper, the printer can be operable to draw paper from the used paper tray 15, or from a paper feed tray 130 if it holds used paper. The recycling printer 100 can be operable to determine the areas that have been printed upon on the previously printed upon paper, and cover the previously printed upon areas on that paper (whether from inkjet or laserjet), resulting in newly recycled paper. Then, recycling printer 100 can print the requested document to be printed by the user (from the Word or Adobe application) onto the newly recycled paper. In this operation, a user does not need to take a recycled piece of paper processed by the recycling printer 100 and then put it into a paper tray. The recycling of the used paper is followed by the printout of the document onto the newly recycled piece of paper.

The recycling printer 100 can also be set to print, by default, using paper drawn from used paper tray 125. Additionally, the recycling printer 100 can be set by default to print on a clean piece of paper, drawing paper from new paper tray 120. If the user wants to change the default to print on recycled paper processed from paper drawn from the used paper tray 125, he or she can do so, for example, using printer management software on his or her computer, laptop, tablet, mobile device, or the like, or from the user input interface 110.

In example embodiments, the recycling printer can output the newly recycled paper, which can be put back into a paper tray that holds newly recycled paper, which is indicated as newly recycled paper tray 140. Thus, the user can print formal, clean documents (e.g., submitted court papers, resumes, or anything else requiring neatness) from paper drawn from the new paper tray 120, or the user can print on recycled paper that was drawn from the used paper tray 125 and processed and output by the recycling printer 100.

Sometimes only one or a few lines are printed on a piece of paper, for example when a person prints out 6 pages but the last page only includes some information unrelated to the core information that the person is trying to print out. Thus, an entire sheet of paper with just a few lines on it might be thrown out, either into the garbage destined for a landfill, or to be recycled using the typical recycling process above. The recycling printer 100 and methods described in this application can obviate the need for having a substantial amount of paper being recycled using the process described in the background of the application. A person using the recycling printer 100 can recycle paper locally—in their own home, or even at a school or office building. Paper can thus be recycled and reused without transporting previously printed upon paper (shredded or intact) to a recycling center and plant, and going through the recycling plant process. This can save the user money as the user can re-use paper, and further, is beneficial for the environment, and contributes to environmental sustainability, by saving fuel costs of transporting paper to a recycling plant and by saving energy used at a mill or recycling plant.

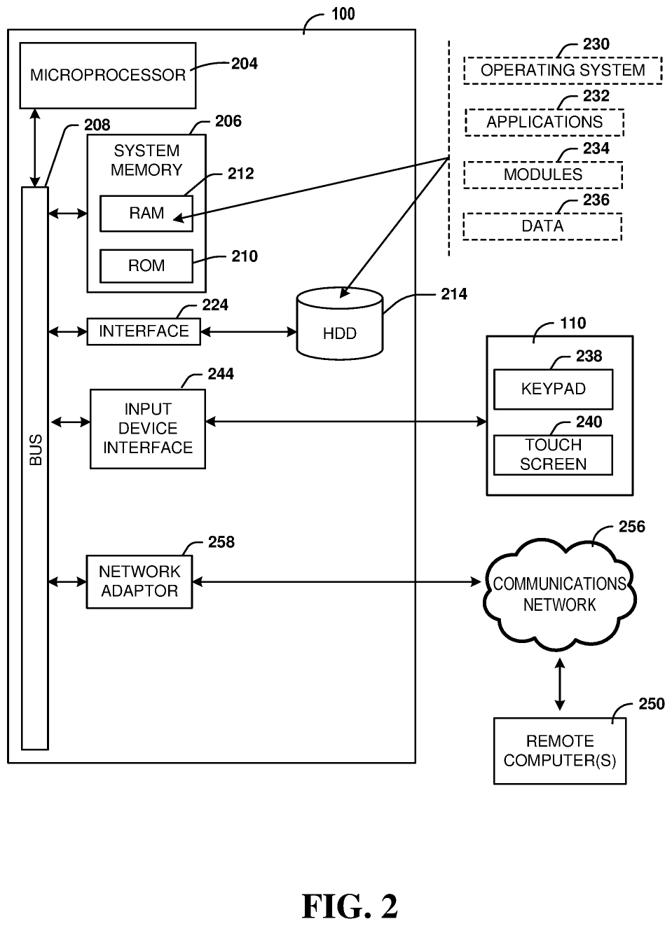

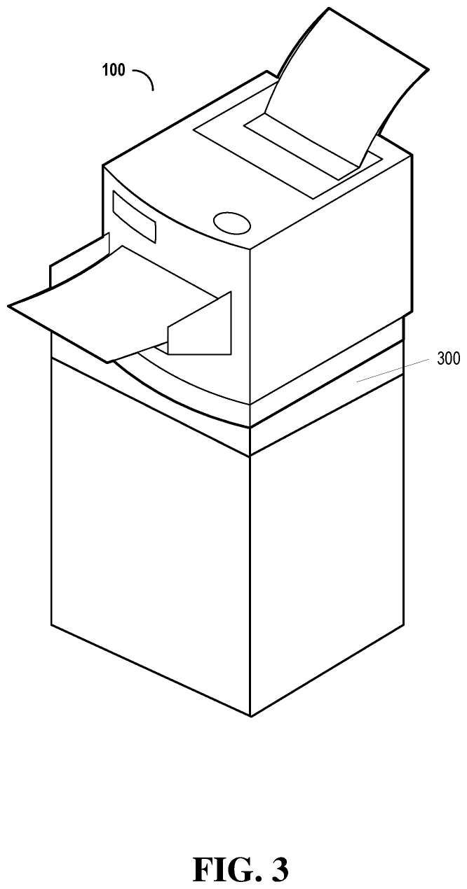

Now moving to FIG. 2, the recycling printer 100 can include electronics related components that enable operation of the recycling printer 100. It can comprise a microprocessor 204 (of referred to as a processing unit, central processing unit, processor). The microprocessor 204 (which can also be one or more microprocessors) can execute machine executable instructions (e.g., computer program product, computer-readable instructions, software, software programs, software applications, software modules, etc.) to facilitate performance of the operations (e.g., functions, methods, processes, and logic flows) described herein. The microprocessor 204 can be any of various commercially available processors capable of performing the functions described herein, and can include brands sold by Intel, AMD, etc.

The recycling printer 100 can also comprise a computer readable media, such as memory 206, which can include read only memory ROM 210, a non-volatile memory, and random-access memory RAM 212. The ROM 210 can store, for example, a basic input/output system (BIOS), an operating system 230, applications 232 of the recycling printer 100, and other computer modules 234, and generated data 236. The RAM 212, which is often called “working memory,” can also include a high-speed RAM such as static RAM for caching data. Other tangible and/or non-transitory media can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

A system bus 208 can connect system components including, but not limited to, the system memory 206 to the microprocessor 204. The system bus 208 can be any of several types of bus structure that can further interconnect to a memory bus (with or without a memory controller), a peripheral bus, and a local bus using any of a variety of commercially available bus architectures.

The recycling printer 100 can also comprise an internal hard disk drive (HDD) 214 (e.g., EIDE, SATA), which can be connected via a storage interface 224 to the system bus 208. The recycling printer 100 can also interface (e.g., USB interface) with any number of external storage devices (e.g., a memory stick or flash drive reader can allow a flash drive to be connected to the recycling printer, to facilitate printing of documents stored on the flash drive). Additionally, a solid-state drive (SSD) could be used in addition to, or in place of, an HDD 214.

A user can enter commands and information into the recycling printer 100 using a user input interface, labeled in FIG. 2 as user input interface 110. The user interface 110 can comprise a keypad 238 and a touch screen 240, and the user input interface 110 can be coupled to the system bus 208 via an input device interface 244.

The recycling printer 100 can operate in a networked environment using logical connections via wired and/or wireless communications via a communications network 256 to one or more remote computers, such as a remote computer 250. The remote computer 250 can be a server with access to networked storage (e.g., cloud storage devices), a desktop computer, laptop, smartphone, tablet, or the like. The communications network can be a local area network (LAN, which wired or wireless network, such as a Wi-Fi network. The communications network can also comprise larger networks (e.g., a wide area network (WAN)) that facilitate enterprise-wide computer networks, such as intranets, all of which can connect to a global communications network, e.g., the Internet. A wireless communication network interface or network adapter 258 can facilitate wired or wireless communication to the communications network 256.

The recycling printer 100 in example embodiments can also have security capability. The recycling printer 100 can use character recognition software (e.g., optical character recognition software), which can be stored in system memory 206 and executed by microprocessor 204, to determine if used paper has printed on it a social security number or EIN number of a company, or any other information that might be deemed to be sensitive (e.g., headers or footers with confidentiality notices). If the previously printed upon paper has such sensitive information printed upon it, rather than print over this sensitive information via the recycling process described herein, which might still result in a would-be-identity thief determining the sensitive information, the recycling printer 100 is operable to, in response to determining that the previously printed upon paper contains the sensitive information, direct that the paper be shredded. The recycling printer 100 can be coupled to a shredder 300, which can be attached to a shred bin.

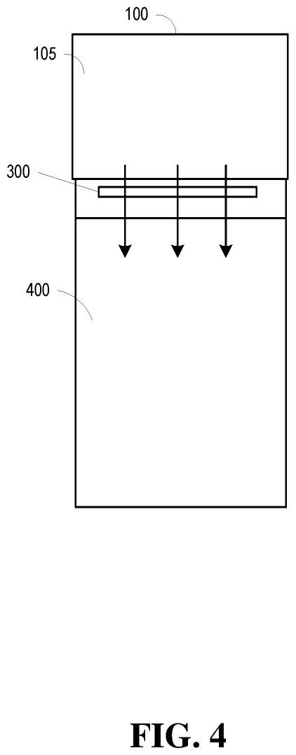

Referring now to FIG. 4, the recycling printer 100 can output the used paper determine to have sensitive information via an output slit, which can be located on the underside of the recycling printer 100. The output of the used from the output slit can be fed into the input of the shredder 300, which like typical shredders can comprise moving knives and a motor. In example embodiments, the shredder can be a micro-cut shredder, cross-cut shredder, the like. Once shredded, the shredded paper can be collected in a bin, e.g., shred bin 400.

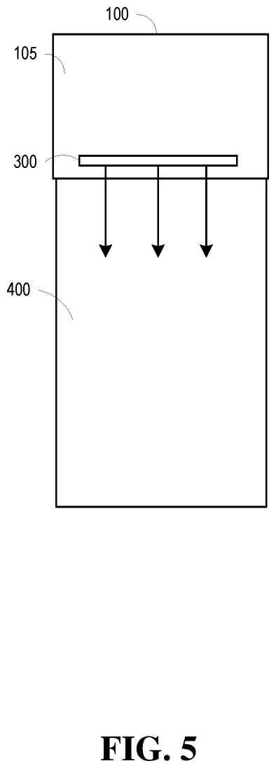

Now referring to FIG. 5, the recycling printer 100 can have a shredder 300 integrated with it (for example, approximately within the housing 105 of the recycling printer 100). Here, used paper determined to contain the sensitive information would be shredded by the shredder 300. Once shredded, the shredded paper can be collected in a bin, e.g., shred bin 400, which can be attached to the recycling printer 100.

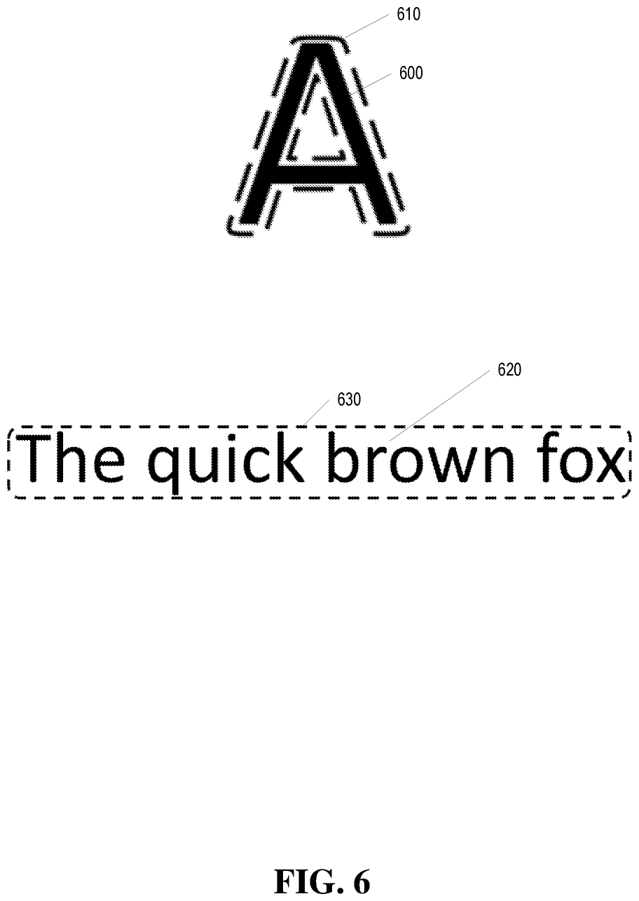

FIG. 6 depicts an illustration of the operation of the recycling printer 100. Here, the recycling printer can use pattern recognition to determine the areas of used papers that contained printed text or images. For example, the letter A 500 can be printed on the paper in black color. The recycling printer 100 can direct white printing such that the letter A is fully covered or substantially covered in white ink or toner. For example, the area of coverage can correspond to the portion illustrated by dotted line 510, which would enclose an area that would cover the A.

Still referring to FIG. 6, as an illustrative example, a block of letters might be printed on the used paper as “The quick brown fox” 620. The recycling printer 100 can be operable to cover a broader area, for example the area enclosed by dashed block 630. Thus, in this incidence, this area would be printed over in white.

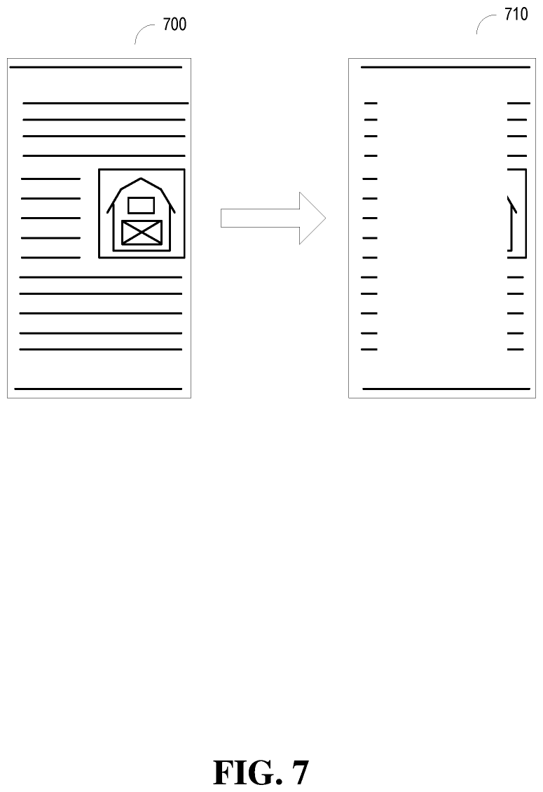

Referring now to FIG. 7, illustrating another example, the recycling printer can be operable to print, in accordance with FIG. 6, only in the area inside of, for example, the margins of the used paper 700. Thus, letters or words would be covered with white ink or toner, but only the ones inside, for example, the top, bottom, right, and left margins, the dimensions of which can be configurable by the user. The resulting recycled paper 710 as shown in FIG. 7 might have some areas that still has previous printing on it, but it the paper can still be usable to take notes, use as scratch paper, etc. The illustrations in FIGS. 6 and 7 are but variations in coverage, but have different implications as to amount of white toner or ink that would be required to covered the defined areas and produce the recycled paper. These tolerances or areas can also be configured or selected by the user.

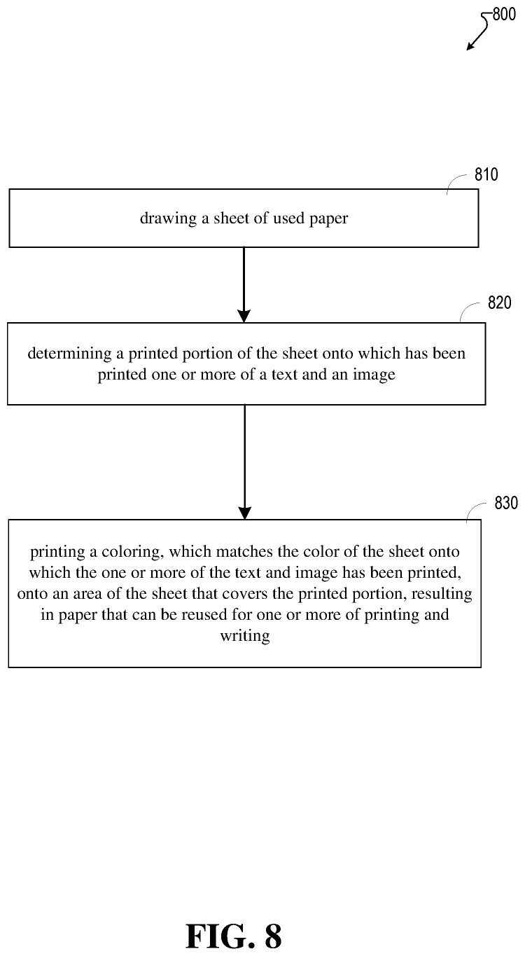

In each of the example operations described above, and below in FIGS. 8-10, steps, blocks, features, or aspects can be substituted or combined with other steps, blocks, features, or aspects, unless context warrants that such combinations or substitutions are not possible. Further, if a step, block, feature, or aspect is not described with respect to example operations, this does not mean that the feature, step, or aspect is incompatible or impossible with respect to those example operations. As such, the example operations of the present application described above and below are not necessarily limited to the steps, features, or aspects that are described with respect to those example operations.

FIG. 8 depicts example operations 800 that can be performed by a recycling printer (e.g., recycling printer 100), which can comprise a microprocessor and a memory (or other non-transitory storage medium) that stores machine readable and executable instructions that, when executed by the microprocessor, facilitate performance of example operations 800. The printer can function as one or more of a printer, fax machine, copier, and email client.

The example operations 800 can comprise, at 810, drawing a sheet of used paper. The method of claim 1, wherein the sheet of used paper is drawn from a used paper tray (used paper tray 125). The used paper can be drawn from a paper feed tray (paper feed tray 130).

The example operations 800 can comprise, at 820, determining a printed portion of the sheet of used paper onto which has been printed one or more of a text and an image. The determining can be performed by the printer using pattern recognition software.

The example operations 800 can comprise, at 830, printing a coloring onto an area of the sheet of used paper that covers the printed portion, resulting in paper that can be reused for one or more of printing and writing. The coloring can be substantially the same color as the color of the used paper onto which the one or more of the text and image has been printed (e.g., if the paper is white, the coloring can be substantially white). If the printer comprises an inkjet printer, the coloring comprises ink. The ink can be white ink, and the white ink can be stored in an ink cartridge associated with the printer. If the printer comprises a laser printer, the coloring comprises toner. The coloring can comprise white toner, and the white toner can be stored in a toner cartridge associated with the printer.

The example operations 800 can also comprise, prior to printing the coloring that covers the printed portion, determining whether the printed portion contains sensitive information. In response to determining that the printed portion contains sensitive information, the operations can comprise directing the shredding of the sheet of used paper. The shredding can be performed by a shredder integrated with the printer (e.g., as shown in FIG. 5). Alternatively, the shredding is performed by a shredder connected to the printer (e.g., as shown in FIG. 4).

Furthermore, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

The term “facilitates” as used herein is in the context of a system, device, or component “facilitating” one or more actions, methods, or example operations, in respect of the nature of complex computing environments in which multiple components and/or multiple devices can be involved in some computing operations. Non-limiting examples of actions that may or may not involve multiple components and/or multiple devices comprise the methods described herein, including but not limited to transmitting or receiving data, establishing a connection between devices, determining intermediate results toward obtaining a result, etc. In this regard, a computing device or component can facilitate an operation by playing any part in accomplishing the operation (e.g., directing, controlling, enabling, etc.). When operations of a component are described herein, it is thus to be understood that where the operations are described as facilitated by the component, the operations can be optionally completed with the cooperation of one or more other computing devices or components, such as, but not limited to, processors, application specific integrated circuits (ASICs), sensors, audio and/or visual output devices, other devices, etc.

In particular and in regard to the various functions performed by the above described components, devices, circuits, systems and the like, any claim terms comprising a reference to a “means” used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments comprise a system as well as a computer-readable medium comprising computer-executable instructions for performing the acts and/or events of the various methods. Further, unless the term “means” appears in a claim, the claim is not to be defined or construed as a means plus function claim.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature can be combined with one or more other features of the other implementations as may be desired and advantageous for any given or particular application. Furthermore, to the extent that the terms “have”, “having”, “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art can recognize that other embodiments comprising modifications, permutations, combinations, and additions can be implemented for performing the same, similar, alternative, or substitute functions of the disclosed subject matter, and are therefore considered within the scope of this disclosure.

For example, disclosed systems and apparatuses and components or subsets thereof (referred to hereinafter as components) should neither be presumed to be exclusive of other disclosed systems and apparatuses, nor should an apparatus be presumed to be exclusive to its depicted components in an example embodiment or embodiments of this disclosure, unless where clear from context to the contrary. Additionally, blocks as shown in example methods, or operations, can be interchangeable with steps or blocks as show in other example methods/operations, and do not necessarily need to be performed in the order depicted.

The scope of this disclosure is generally intended to encompass modifications of depicted embodiments with additions from other depicted embodiments, where suitable, interoperability among or between depicted embodiments, where suitable, as well as addition of a component(s) from one embodiment(s) within another or subtraction of a component(s) from any depicted embodiment, where suitable, aggregation of components (or embodiments) into a single component achieving aggregate functionality, where suitable, or distribution of functionality of a single system or component into multiple systems or components, where suitable. In addition, incorporation, combination or modification of systems or components depicted herein or modified as stated above with systems, apparatuses, components or subsets thereof not explicitly depicted herein but known in the art or made evident to one with ordinary skill in the art through the context disclosed herein are also considered within the scope of the present disclosure.

Therefore, the disclosed subject matter should not be limited to any single embodiment described herein, but rather should be construed in breadth and scope in accordance with the claims below.

What is claimed is:

1. A method, comprising:
drawing a sheet of used paper;
determining a printed portion of the sheet onto which has been printed one or more of a text and an image; and
printing a coloring, which matches the color of the sheet onto which the one or more of the text and image has been printed, onto an area of the sheet that covers the printed portion, resulting in paper that can be reused for one or more of printing and writing.

2. The method of claim 1, wherein the printer can function as one or more of a printer, fax machine, copier, scanner, and email client.

3. The method of claim 2, wherein the printer comprises an inkjet printer, and the coloring comprises ink.

4. The method of claim 3, wherein the coloring comprises white ink, and wherein the white ink is stored in an ink cartridge associated with the printer.

5. The method of claim 2, wherein the printer comprises a laser printer, and the coloring comprises toner.

6. The method of claim 5, wherein the coloring comprises white toner, and wherein the white toner is stored in a toner cartridge associated with the printer.

7. The method of claim 1, wherein the sheet of used paper is drawn from a used paper tray.

8. The method of claim 1, wherein the sheet of used paper is drawn from a paper feed tray.

9. The method of claim 1, wherein the determining is performed using pattern recognition software.

10. The method of claim 1, wherein, prior to printing the coloring that covers the printed portion, determining whether the printed portion contains sensitive information.

11. The method of claim 10, wherein, in response to determining that the printed portion contains sensitive information, directing the shredding of the sheet of used paper.

12. The method of claim 11, wherein the shredding is performed by a shredder integrated with the printer.

13. The method of claim 11, wherein the shredding is performed by a shredder connected to the printer.

14. A printing device, comprising:
a microprocessor; and
a memory that stores executable instructions that, when executed by the processor, facilitate performance of operations comprising:
drawing a sheet of used paper;
determining a printed portion of the sheet onto which has been printed one or more of a text and an image; and
printing a coloring, which matches the color of the sheet onto which the one or more of the text and image has been printed, onto an area of the sheet that covers the printed portion, resulting in paper that can be reused for one or more of printing and writing.

15. The method of claim 14, wherein the printer can function to perform one or more of print, fax, copy, scan, and email.

16. The method of claim 15, wherein the printer comprises an inkjet printer, and the coloring comprises white ink stored in an ink cartridge associated with the printer.

17. The method of claim 15, wherein the printer comprises a laser printer, and the coloring comprises white toner stored in a toner cartridge associated with the printer.

18. The method of claim 1, wherein the sheet of used paper is drawn from a used paper tray.

19. The method of claim 1, wherein the sheet of used paper is drawn from a paper feed tray.

20. A printer that is capable of performing operations comprising:
drawing a sheet of used paper from the paper source;
determining a printed portion of the sheet onto which has been printed one or more of a text and an image; and
printing a coloring, which substantially matches the color of the sheet onto which the one or more of the text and image has been printed, onto an area of the sheet that covers the printed portion, resulting in paper that can be reused.
